(19) United States
(12) Patent Application Publication
(10) Pub. No.: US 2026/0098554 A1
(43) Pub. Date: Apr. 9, 2026

(54) Fastening System with Damper

(71) Applicant: Illinois Tool Works Inc., Glenview, IL (US)

(72) Inventor: Scott M. Liebelt, Eau Claire, WI (US)

(21) Appl. No.: 19/327,109

(22) Filed: Sep. 12, 2025

Related U.S. Application Data
(60) Provisional application No. 63/702,799, filed on Oct. 3, 2024.
(60) Provisional application No. 63/747,462, filed on Jan. 21, 2025.

(51) Int. Cl. F16B 5/02; B60N 3/04

(52) U.S. Cl. CPC F16B 5/0258; B60N 3/046

(57) ABSTRACT

Disclosed is a fastener assembly for coupling a first component to a second component in a vehicle. The fastener assembly includes a first assembly and a second assembly. The first assembly includes a cap and a female eyelet to couple with one another where the first component sandwiched therebetween. The second assembly includes a base assembly and a male eyelet to couple to one another where the second component is sandwiched therebetween. The base assembly includes a damper and a locking ring having a base and a flange with an opening formed therethrough. The locking ring mechanically engages with a male eyelet via the opening and a skirt extending from the male eyelet. The damper is configured to mitigate buzz, squeak, and rattle (BSR) noise between the base and the vehicle.

### RELATED APPLICATION

The present application claims priority to U.S. Provisional Patent Application Nos. 63/702,799, filed Oct. 3, 2024, and 63/747,462, filed Jan. 21, 2025, each of which is hereby incorporated by reference in its entirety.

### TECHNICAL FIELD

The present disclosure relates to a fastener assembly, and more specifically to a fastener assembly configured to secure a mat to a carpet in a vehicle.

### BACKGROUND

Automotive components require fastening solutions that are both straightforward to manufacture and easy to assemble. These fastening methods must prioritize reliability and efficiency, particularly within the demanding environment of vehicle interiors. One common application is the secure attachment of mats to carpets, which is essential to prevent movement and enhance safety during vehicle operation. A practical solution for this purpose is the use of a carpet fastener, which provides a stable and durable connection between the mat and the carpet.

Carpet fasteners typically include a base assembly that sandwiches the carpet and a female element that sandwiches the mat. The base assembly includes a head that projects through the carpet, while the female element is designed to interlock with the head of the base assembly, thereby fixing the mat to the carpet. An example of such a carpet fastener is described in commonly-owned U.S. Pat. No. 8,402,605, which outlines a mechanism for mat and carpet attachment in automotive applications.

Despite advancements in carpet fastener designs, there remains a need for innovations that mitigate issues such as buzz, squeak, and rattle (BSR) noise. These noises can detract from the overall quality and comfort of the vehicle interior.

Accordingly, there is a desire to develop a carpet fastener that not only provides secure and efficient attachment but also minimizes the generation of BSR noise, thereby enhancing the vehicle's interior experience.

### SUMMARY

The present disclosure relates generally to fasteners, substantially as illustrated by and described in connection with at least one of the figures, as set forth more completely in the claims. More specifically, the present disclosure relates to fasteners for fixing a first component to a second component, such as a mat to a carpet, particularly in a vehicle.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate, respectively, assembly and partially assembled side views of an example fastening system configured to coupled first component to a second component using a fastener assembly in accordance with aspects of this disclosure.

FIGS. 1c and 1d illustrate, respectively, assembly and assembled side views of a second component assembly of the fastening system in accordance with aspects of this disclosure.

FIG. 1e illustrates a cross-sectional assembled side view of the second component assembly taken along cut line A-A (FIG. 1d).

FIGS. 2a and 2b illustrate, respectively, topside and underside isometric views of the base assembly.

FIGS. 2c, 2d, 2e, and 2f illustrate, respectively, first, second, third, and fourth side elevation views of the base assembly.

FIGS. 2g and 2h illustrate, respectively, top and bottom plan views of the base assembly.

FIGS. 3a and 3b illustrate, respectively, assembled and assembly underside isometric views of the second component assembly.

FIGS. 3c and 3d illustrate, respectively, top and bottom plan assembly views of the second component assembly.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosed fastener assembly provides a secure and stable attachment of first components to second components, such as mats to vehicle carpets. The various rigid, structural components of the fastener assembly can be molded from durable plastic, ensuring long-term reliability, while a sound-dampening material can be attached to, or formed on, one or more surfaces of the fastener assembly adjacent the floor. The fastener assembly is compatible with varying carpet and mat thicknesses, and its design facilitates easy installation and disassembly. Increased bearing surface of the fastener assembly improves stability and further does not allow the fastener assembly to rock.

In one example, a base assembly for use in a fastener assembly to couple a first component to a second component in a vehicle comprises a locking ring having a base and a flange with an opening formed therethrough, wherein the locking ring is configured to mechanically engage with a male eyelet via the opening and a skirt extending from the male eyelet; and a damper coupled to the base, wherein the damper is configured to mitigate buzz, squeak, and rattle (BSR) noise between the locking ring and the vehicle.

In another example, a fastener assembly for coupling a first component to a second component in a vehicle comprises a first assembly having a cap and a female eyelet configured to couple to one another with the first component sandwiched therebetween; and a second component assembly having a base assembly and a male eyelet configured to couple to one another with the second component sandwiched therebetween; and wherein the base assembly includes a damper and a locking ring having a base and a flange with an opening formed therethrough, wherein the locking ring is configured to mechanically engage with a male eyelet via the opening and a skirt extending from the male eyelet, and wherein the damper is configured to mitigate buzz, squeak, and rattle (BSR) noise between the base and the vehicle.

In yet another example, a fastener assembly for coupling a first component to a second component in a vehicle comprises a first assembly having a cap and a female eyelet configured to couple to one another with the first component sandwiched therebetween; and a second component assembly configured to couple with the female eyelet of the first assembly, the second assembly having a base assembly and a male eyelet configured to couple to one another with the second component sandwiched therebetween; wherein the base assembly includes a damper and a locking ring having a base and a flange with an opening formed therethrough, wherein the locking ring is configured to mechanically engage with a male eyelet via the opening and a skirt extending from the male eyelet, wherein the damper is configured to mitigate buzz, squeak, and rattle (BSR) noise between the base and the vehicle, and wherein the locking ring is formed from a rigid material and the damper is formed from a pliable material.

In some examples, the damper comprises an annular portion coupled to one or more retainer portions via at least one bridge portion.

In some examples, the annular portion is positioned on a first side of the locking ring and the one or more retainer portions are positioned on a second side of the locking ring that is opposite the first side.

In some examples, the at least one bridge portion is configured to pass through the locking ring via one of more passageways formed in the locking ring.

In some examples, the annular portion comprises one or more indentations configured to accommodate one or more features of the base.

In some examples, the locking ring is formed from a rigid material.

In some examples, the damper is formed from a pliable material.

In some examples, the damper is over-molded onto the locking ring.

In some examples, the locking ring comprise a plurality of retaining tabs that extend into the opening.

In some examples, the retaining tabs are configured to engage notches formed on an outer surface of the skirt.

In some examples, the retaining tabs are evenly distributed around the opening.

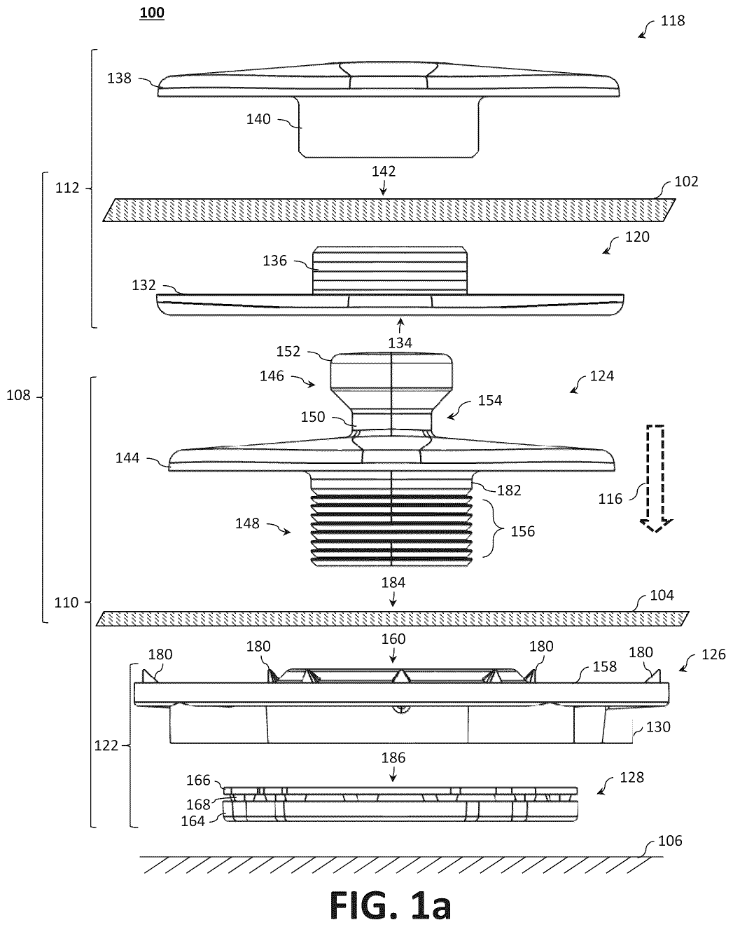

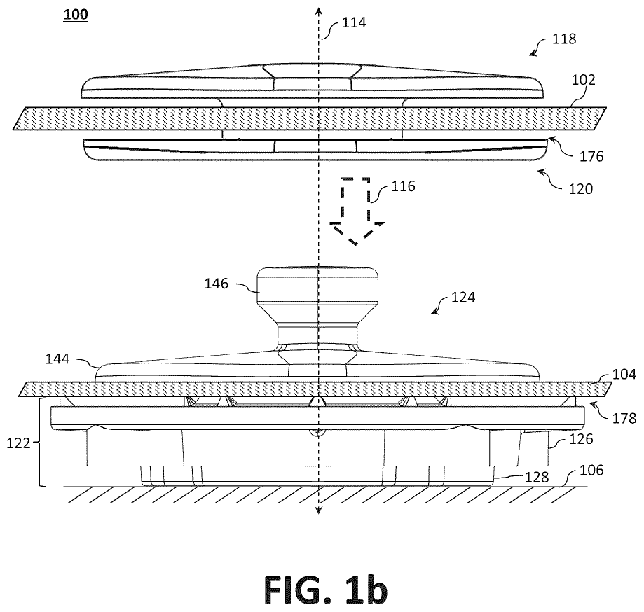

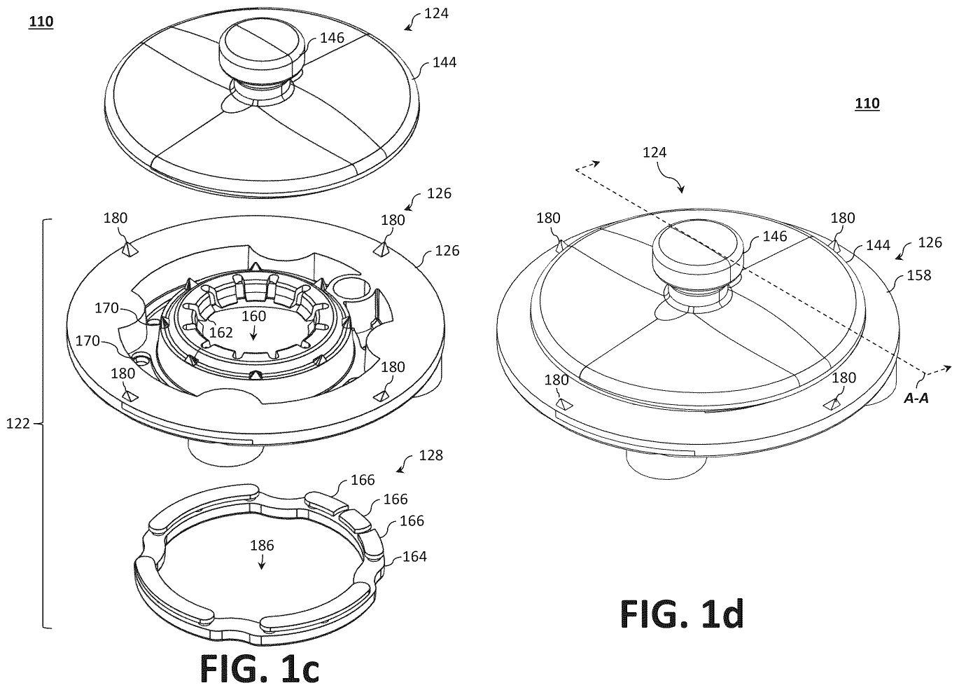

FIGS. 1a and 1b illustrate, respectively, assembly and partially assembled side views of an example fastening system 100 configured to couple a first component 102 (e.g., a mat, such as those in the footwell of a vehicle) to a second component 104 (e.g., a carpet) on a vehicle floor 106 using a fastener assembly 108 in accordance with this disclosure. As illustrated, the fastener assembly 108 includes a second assembly 110 and a first assembly 112. The first assembly 112 engages the second assembly 110 when urged along the central axis 114 in the direction indicated by arrow 116. The second assembly 110 retains the first assembly 112 via a mechanical connection and/or interference fit. As will be discussed, the various rigid components of the fastener assembly 108 can primarily be molded from plastic materials.

The first assembly 112 includes a cap 118 and a female eyelet 120, which are configured to couple to one another with the first component 102 sandwiched between them. For example, the cap 118 and the female eyelet 120 are connected to one another but are sufficiently spaced apart at the outer perimeter to define an annular recess 176 configured to receive a portion of the first component 102 adjacent to an opening 142 formed in the first component 102. The height of the annular recess 176 can be dictated by the thickness of the first component 102. In some examples, the height of the annular recess 176 can be slightly less than the thickness of the first component 102 to compress and retain the first component 102.

Similarly, the second assembly 110 includes a base assembly 122 and a male eyelet 124, which are configured to couple to one another with the second component 104 sandwiched between them. For example, the base assembly 122 and the male eyelet 124 are connected to one another but are sufficiently spaced apart at the outer perimeter to define an annular recess 178 configured to receive a portion of the second component 104 adjacent to an opening 184 formed in the second component 104. The height of the annular recess 178 can be dictated by the thickness of the second component 104. In some examples, the height of the annular recess 178 can be slightly less than the thickness of the second component 104 to compress and retain the second component 104. One or both of the annular recesses 176, 178 can contain a plurality of protrusions to dig into their respective first component 102 or second component 104. For example, the illustrated base assembly 122 comprises a plurality of protrusions 180 extending away from the base assembly 122 and into the annular recess 178. The protrusions 180 are illustrated as pyramidal spikes, though other shapes are contemplated.

FIGS. 1c and 1d illustrate, respectively, assembly and assembled side views of the second assembly 110 of the fastening system 100, while FIG. 1e shows a cross-sectional assembled side view of the second assembly 110 along cut line A-A FIG. 1d. As illustrated, the second assembly 110 includes a base assembly 122 that includes a locking ring 126 and a damper 128 designed to mitigate buzz, squeak, and rattle (BSR) noise from contact between the locking ring 126 and the floor 106, thus serving as an anti-rattle isolator.

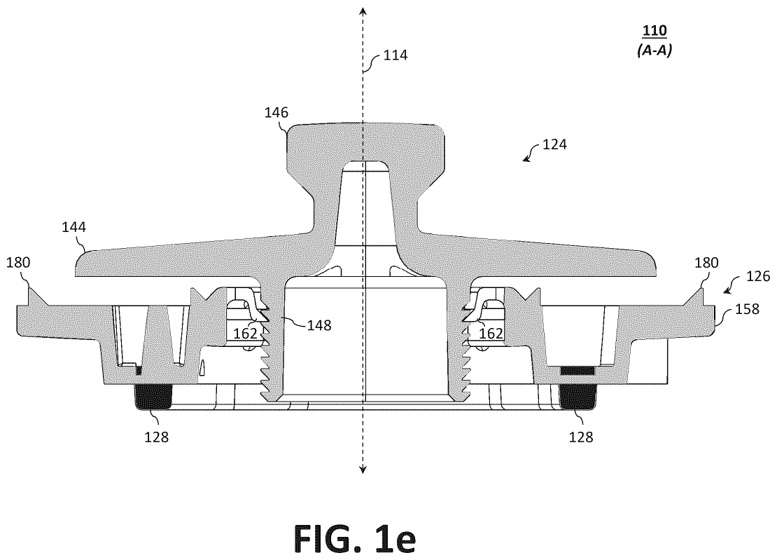

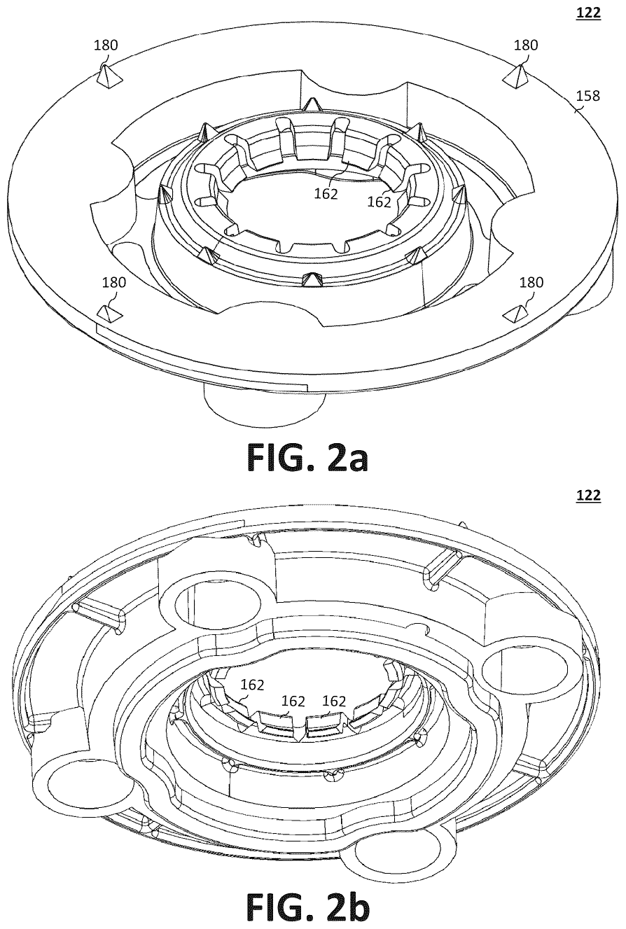

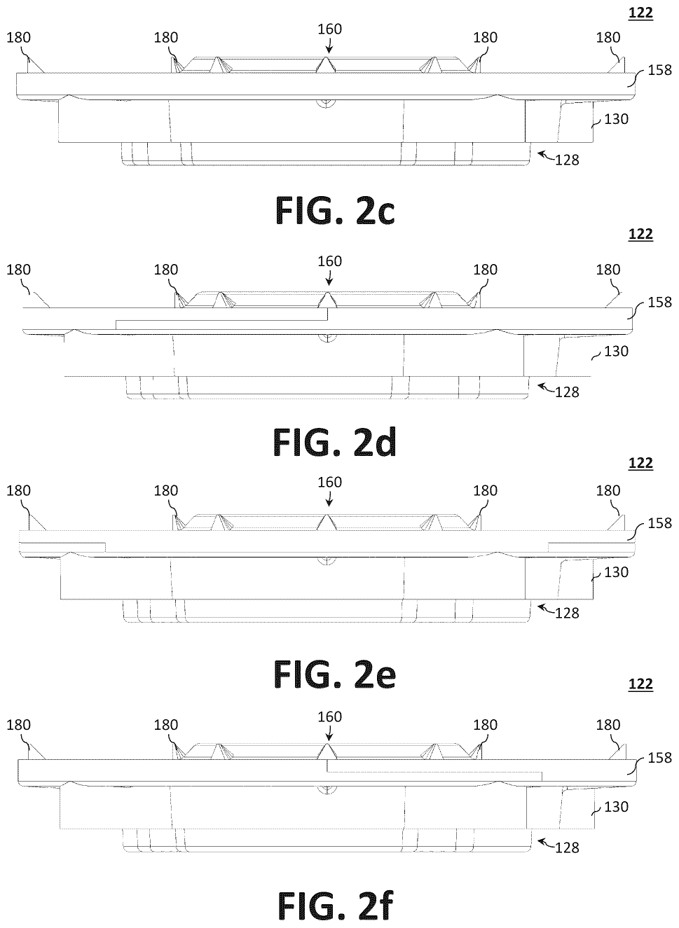

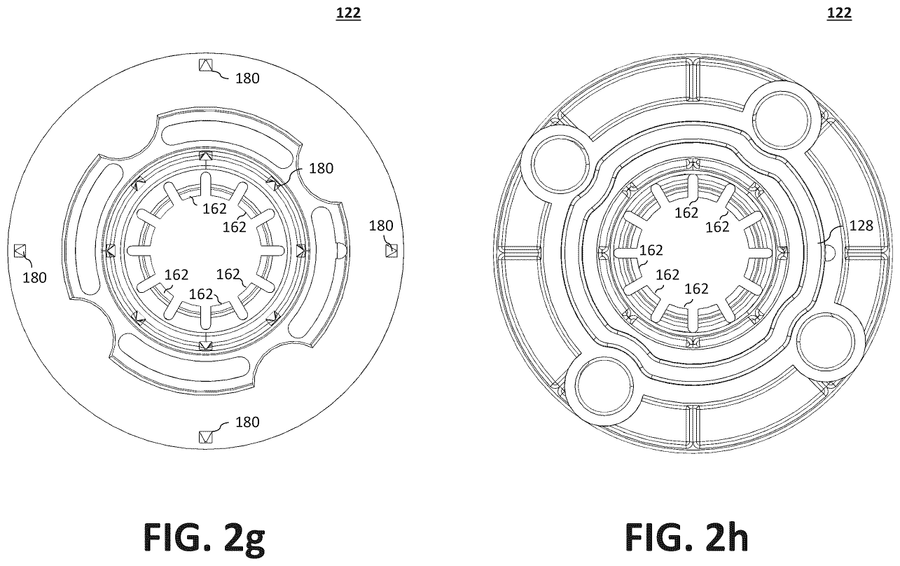

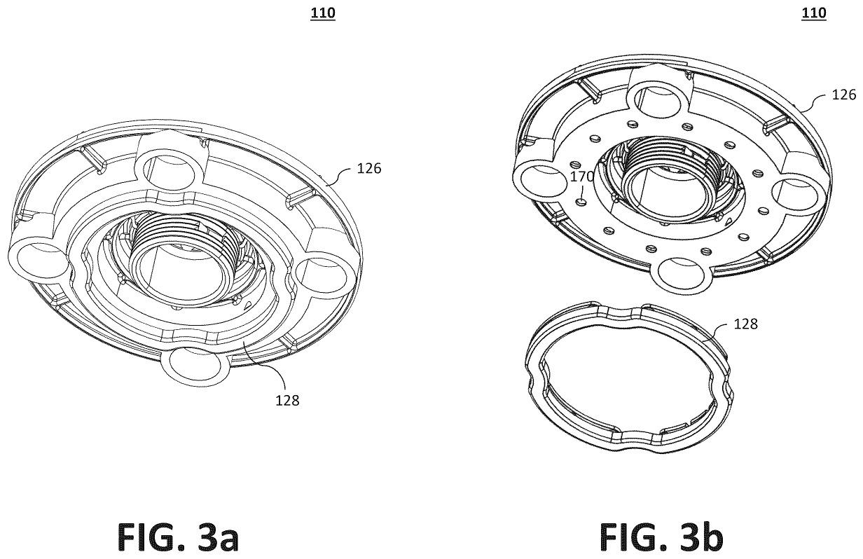

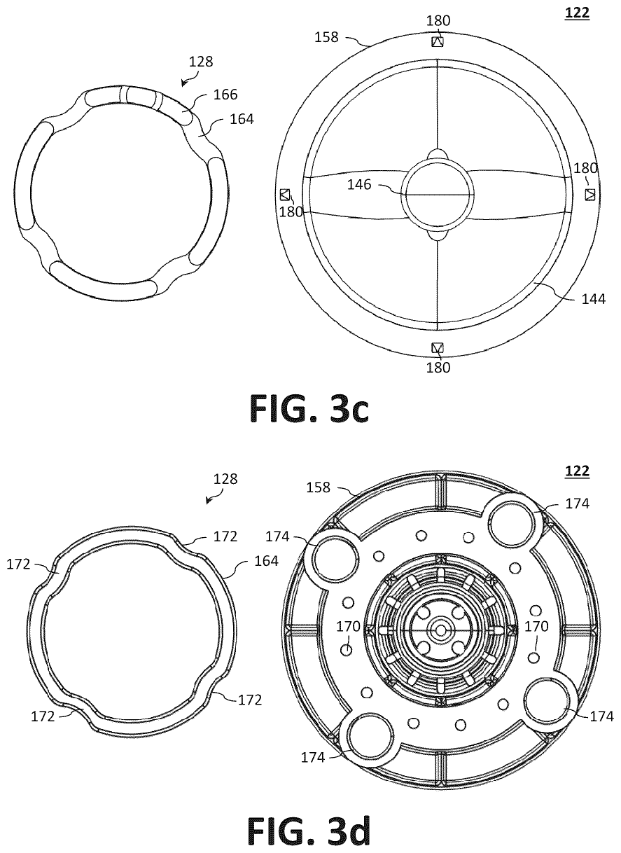

FIGS. 2a and 2b depict, respectively, topside and underside isometric views of the base assembly 122. FIGS. 2c through 2f provide first, second, third, and fourth side elevation views of the base assembly 122, while FIGS. 2g and 2h show top and bottom plan views of the base assembly 122. The base assembly 122 includes a locking ring 126 and a damper 128. Additional details of the damper 128 are shown in FIGS. 3a through 3d. FIGS. 3a and 3b illustrate, respectively, assembled and assembly underside isometric views of the second assembly 110. FIGS. 3c and 3d illustrate top and bottom plan views of the second assembly 110 with the damper 128 removed.

In practice, the damper 128 is integral with the locking ring 126 (i.e., permanently attached) and is positioned on or adjacent a base 130 of the locking ring 126; however, for ease of illustration, the damper 128 is illustrated separately in certain figures to better illustrated its features and shape. Therefore, while the damper 128 is shown as a separate, stand-alone component for illustrative purposes, it is contemplated that the damper 128 would be integrated with the locking ring 126 as a single, integrated multi-material component via over-molding manufacturing process or a 2-shot manufacturing process. Accordingly, the present disclosure should not be construed as requiring that the damper 128 be separately manufactured, and then later applied to the locking ring 126; however, such a manufacturing process is possible where desired.

The first assembly 112 comprises the female eyelet 120 and the cap 118. The female eyelet 120 comprises a flat annular flange 132 with a central circular orifice 134 surrounded by a collar 136. The collar 136 is notched or threaded externally and smooth internally. The cap 118 includes a component flange 138 with a domed center and an annular collar 140 matching the collar 136, enabling interlocking. Together, the flange 132 and the component flange 138 sandwich the first component 102 at an opening 142 formed therein.

The second assembly 110 includes the male eyelet 124 and the base assembly 122. The male eyelet 124 comprises a flat flange 144, a mushroom-shaped head 146, and a skirt 148. The head 146 includes a cylindrical base 150 and a cap 152, with an annular recess 154 formed between the cap 152, base 150, and flange 144. The skirt 148 features a smooth region 182 and a notched portion 156 (e.g., ridge or threading) for securing the locking ring 126. The smooth region 182 generally corresponds to the thickness of the second component 104.

The locking ring 126 comprises a flange 158 and the base 130. The flange 158 and the base 130 are concentric with the central axis 114 and define an opening 160 therethrough that is positioned at a center of the locking ring 126. The opening 160 is configured to receive and retain the skirt 148. The locking ring 126 further comprise a plurality of retaining tabs 162 that extend into the opening 160 toward the central axis 114. The retaining tabs 162 are configured to engage the notched portion 156 formed on the outer surface of the skirt 148 when assembled. As best illustrated in FIGS. 2g and 2h, the plurality of retaining tabs 162 is formed on an interior perimeter of the opening 160. The plurality of retaining tabs 162 can be evenly distributed around the opening 160.

The damper 128 reduces BSR by contacting the floor 106 via a annular portion 164 that includes retainer portions 166 connected to the annular portion 164 via bridge portions 168 that pass through one of more passageways 170 of the locking ring 126. The damper 128 can be over formed on the base 130. In one example, the damper 128 can be formed by injecting the second material through the locking ring 126 from an end adjacent to the flange 158 via one of more passageways 170 (e.g., channels, conduits, etc.) and out an end adjacent to the base 130. As illustrated, one of more passageways 170 can be formed through the locking ring 126 and configured to extend between the flange 158 and base 130. For example, each of the one of more passageways 170 can be a hole formed around the opening 160.

The damper 128 can be embodied as an annular portion 164 having a plurality of retainer portions 166 coupled to, but spaced from, the annular portion 164 via one or more ridge portions 168. The annular portion 164 is annular in that it includes a through hole 186. The annular portion 164 can be circular, oval, or another shape a dictated by the shape of the base 130 or its features. For example, in some examples, as illustrated, the annular portion 164 can be shaped with indentations 172 and/or protrusions to accommodate and/or avoid one or more features of the base 130, such as the circular posts 174. In the illustrated example, each of the one of more passageways 170 is a round hole; however, other shapes are contemplated.

The passageways 170 are configured to convey the second material as needed between a mold cavity for the annular portion 164 at the base 130 and the flange 158. Where desired, the flange 158 can serve as an entrance to the passageway 170 such that a second material can be injected from the flange side. In this example, the passageway 170 can be configured to receive of otherwise engage a nozzle and to receive the second material.

The damper 128 is attached to the locking ring 126 at the base 130 and via one of more passageways 170. The connection between the locking ring 126 and the damper 128 should be adequate to prevent the damper 128 from detaching from the locking ring 126 prior to, during, and/or post installation, assembly, and/or disassembly by the end user. As noted, the damper 128 can therefore be formed such that the annular portion 164 is positioned on the base 130 via mold tooling and a plastic-injection molding process.

To provide an adequate connection between the locking ring 126 and damper 128, one or both of the locking ring 126 and damper 128 may include one or more interlocking features to increase the bond; thus, providing a higher degree of mechanical retention. For example, at least a portion of the damper 128 (e.g., the bridge portion 168) can extend into or through the one of more passageways 170 such that a portion of the locking ring 126 is sandwiched between the retainer portions 166 and the annular portion 164 with the bridge portion 168 extending therethrough. In this example, the plurality of bridge portion 168 are formed and/or defined by the one of more passageways 170. For example, the material of the damper 128 will conform to the shape of the one of more passageways 170, the base 130, and the mold to ultimately form a base assembly 122.

The locking ring 126 (or other component of the fastener assembly 108) can be made from various materials, including synthetic or semi-synthetic polymers (e.g., plastics, such as acrylonitrile butadiene styrene (ABS) and polyvinyl chloride (PVC), etc.), composite materials (e.g., fiber glass), metal (or a metal alloy), or a combination thereof. Some materials are more conducive for sealing than mechanical attachment. In some examples, the first material is a part material that is generally rigid, such as synthetic or semi-synthetic polymers, composite materials, or a combination thereof. Therefore, the locking ring 126 is fabricated from a first material (e.g., a rigid material) and the damper 128 is fabricated from a second material (e.g., a pliable material) that is different from the first material.

Example rigid materials include, inter alia, nylon (PA), polyetherimide (PEI), polyoxymethylene (POM), polypropylene (PP), high-density polyethylene (HDPE), acrylonitrile butadiene styrene (ABS), polystyrene (PS), and the like. The second material may be a pliable (e.g., flexible and/or conformable seal material, such as a foam material, an elastomeric material (e.g., a thermoplastic elastomer (TPE)), a rubber material (e.g., open cell rubber, closed cell rubber, natural rubber, synthetic rubber, etc.), and the like.

To form the base assembly 122, the locking ring 126 or the damper 128 can be first molded to provide a desired profile, after which the other of the locking ring 126 or the damper 128 may be molded. The order in which the locking ring 126 and the damper 128 are molded will depend on the manufacturing technique employed. For example, in a two-shot (2K) plastic injection process, the locking ring 126 can be molded first due in part to the passageway(s) 170, and the damper 128 can be molded second. An example two-shot injection process is described in commonly owned U.S. Pat. No. 6,752,950 to Martin D. H. Clarke, which is entitled “Two Shot Molding Method and Fastener Clip with Seal Made Thereby.” In other examples, the damper 128 is over-molded onto the base 130 of the locking ring 126.

The base assembly 122 can be fabricated using a two-shot plastic injection molding process that forms a component via a first shot injection and a second shot injection. Two-shot plastic injection molding processes are useful and can be used to create complex parts using multiple colors and/or multiple materials in a single molding operation. By way of illustration, two separate molds can be prepared; one for each portion of the base assembly 122—such as the locking ring 126 and the damper 128. To that end, two-shot injection molding machines can be equipped with multiple barrels and nozzles to accommodate different materials. The molds are mounted onto the machine's platens, and the injection molding machine is configured and calibrated for the specific parameters required for the part.

During the first shot injection, the first material, serving as the substrate or base material, is injected into the mold cavity using one of the machine's nozzles to form the locking ring 126. The mold is then partially cooled to allow the first material to solidify. In some examples, the locking ring 126 can be maintained in a slightly molten state to facilitate bonding with the second shot. Once the locking ring 126 is partially cooled, the mold can be opened slightly, and the second material is injected into the mold cavity to form the damper 128. In some examples, the second material is injected into the mold cavity via a different nozzle and configured to pass at least partially into or through one of more passageways 170 formed in the locking ring 126. After the second shot of material is injected, the mold is fully cooled to solidify both materials to form the base assembly 122. Once cooled, the mold is opened, and the base assembly 122 is ejected from the mold cavity where any excess flash material can be trimmed off.

In another example, one or more components of the base assembly 122 (or other component of the fastener assembly 108) can be a printed thermoplastic material component, which can be printed with great accuracy and with numerous details. In addition, additive manufacturing techniques obviate the need for mold tooling typically associated with plastic injection molding, thereby lowering up-front manufacturing costs, which is particularly advantageous in low-volume productions. In some examples, components of the base assembly 122 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. For example, the locking ring 126 can be a printed thermoplastic material component that is then over-molded with the damper 128.

To install the second assembly 110, the male eyelet 124 is aligned with the skirt 148 and positioned with the skirt 148 passing through the second component 104. The locking ring 126 secures the assembly via engagement of its retaining tabs 162 with the notched portion 156. To install the first assembly 112, the collar 140 of the cap 118 passes through the first component 102 opening, with the flange 132 and component flange 138 interlocking. The first component 102 is secured to the second component 104 by aligning the first assembly 112 with the second assembly 110, where the male eyelet 124 and female eyelet 120 interlock, ensuring stability and durability.

The above-cited patents and patent publications are hereby incorporated by reference in their entirety. While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A base assembly for use in a fastener assembly to couple a first component to a second component in a vehicle, the base assembly comprising:
a locking ring having a base and a flange with an opening formed therethrough, wherein the locking ring is configured to mechanically engage with a male eyelet via the opening and a skirt extending from the male eyelet; and
a damper coupled to the base, wherein the damper is configured to mitigate buzz, squeak, and rattle (BSR) noise between the locking ring and the vehicle.

2. The base assembly of claim 1, wherein the damper comprises an annular portion coupled to one or more retainer portions via at least one bridge portion.

3. The base assembly of claim 2, wherein the annular portion is positioned on a first side of the locking ring and the one or more retainer portions are positioned on a second side of the locking ring that is opposite the first side.

4. The base assembly of claim 3, wherein the at least one bridge portion is configured to pass through the locking ring via one of more passageways formed in the locking ring.

5. The base assembly of claim 2, wherein the annular portion comprises one or more indentations configured to accommodate one or more features of the base.

6. The base assembly of claim 1, wherein the locking ring is formed from a rigid material.

7. The base assembly of claim 6, wherein the damper is formed from a pliable material.

8. The base assembly of claim 7, wherein the damper is over-molded onto the locking ring.

9. The base assembly of claim 1, wherein the locking ring comprises a plurality of retaining tabs that extend into the opening.

10. The base assembly of claim 9, wherein the retaining tabs are configured to engage notches formed on an outer surface of the skirt.

11. The base assembly of claim 10, wherein the retaining tabs are evenly distributed around the opening.

12. A fastener assembly for coupling a first component to a second component in a vehicle, the fastener assembly comprising:
a first assembly having a cap and a female eyelet configured to couple to one another with the first component sandwiched therebetween; and
a second assembly having a base assembly and a male eyelet configured to couple to one another with the second component sandwiched therebetween; and
wherein the base assembly includes a damper and a locking ring having a base and a flange with an opening formed therethrough,
wherein the locking ring is configured to mechanically engage with a male eyelet via the opening and a skirt extending from the male eyelet, and
wherein the damper is configured to mitigate buzz, squeak, and rattle (BSR) noise between the base and the vehicle.

13. The fastener assembly of claim 12, wherein the damper comprises an annular portion coupled to one or more retainer portions via at least one bridge portion.

14. The fastener assembly of claim 13, wherein the annular portion is positioned on a first side of the locking ring and the one or more retainer portions are positioned on a second side of the locking ring that is opposite the first side.

15. The fastener assembly of claim 14, wherein the at least one bridge portion is configured to pass through the locking ring via one of more passageways formed in the locking ring.

16. The fastener assembly of claim 13, wherein the annular portion comprises one or more indentations configured to accommodate one or more features of the base.

17. The fastener assembly of claim 1, wherein the locking ring is formed from a rigid material and the damper is formed from a pliable material.

18. The fastener assembly of claim 17, wherein the damper is over-molded onto the locking ring.

19. A fastener assembly for coupling a first component to a second component in a vehicle, the fastener assembly comprising:
a first assembly having a cap and a female eyelet configured to couple to one another with the first component sandwiched therebetween; and
a second assembly configured to couple with the female eyelet of the first assembly, the second assembly having a base assembly and a male eyelet configured to couple to one another with the second component sandwiched therebetween;
wherein the base assembly includes a damper and a locking ring having a base and a flange with an opening formed therethrough,
wherein the locking ring is configured to mechanically engage with a male eyelet via the opening and a skirt extending from the male eyelet,
wherein the damper is configured to mitigate buzz, squeak, and rattle (BSR) noise between the base and the vehicle, and
wherein the locking ring is formed from a rigid material and the damper is formed from a pliable material.

20. The fastener assembly of claim 19, wherein the damper comprises an annular portion positioned on a first side of the locking ring and the one or more retainer portions are positioned on a second side of the locking ring that is opposite the first side, and wherein the at least one bridge portion is configured to pass through the locking ring via one of more passageways formed in the locking ring.
